(19) United States
(12) Patent Application Publication
(10) Pub. No.: US 2016/0162989 A1
(43) Pub. Date: Jun. 9, 2016

(54) Mobile opportunistic trading markets

(71) Applicants: David John Cole, Viewbank (AU); Andrew Cole, San Jose, CA (US)

(72) Inventors: David John Cole, Viewbank (AU); Andrew Cole, San Jose, CA (US)

(73) Assignee: David John Cole, Viewbank (AU)

(21) Appl. No.: 14/562,709

(22) Filed: Dec. 6, 2014

(51) Int. Cl. G06Q 40/04

(52) U.S. Cl. CPC G06Q 40/04

(57) ABSTRACT

A mobile opportunistic trading system is described where traders list items they wish to trade along with ask prices or offer bids on a trading server. Traders may also include additional information related to the distance or time they are willing to travel in order to trade items. The trading server identifies potential trades and notifies the traders of this. The traders may then organize and participate in an opportunistic market. Traders may also carry mobile computing devices that use a GPS, or other mechanism to determine their present location and communicate this to the trading system. When two or more traders are within an acceptable distance of each other an opportunistic trading market can be created. The mobile opportunistic trading system may also obtain information related to traders travel plans and use this information in order to determine that an opportunistic market is possible.

### CROSS REFERENCE TO RELATED APPLICATIONS

This application claims the benefit of Provisional Patent Application Ser. No. 61/913,387 filed 2013 Dec. 9 by the present inventors, which is incorporated by reference.

### FIELD OF ENDEAVOR

This invention relates to a method and system utilizing mobile computing devices and GPS or other location capabilities to enable traders of goods to create or participate in markets at times and locations that are convenient to the traders.

### BACKGROUND TO THE INVENTION

Electronic trading systems such as that operated by eBay (U.S. Pat. No. 7,904,346 to Grove et al (2003), U.S. Pat. No. 8,005,719 to Grove et al (2003) and U.S. Pat. No. 8,352,328 to Woolston (2010)) provide a mechanism for occasional and regular traders to trade (sell and buy) goods via a market for which they do not need to be present. Sellers are able to list their goods in an electronic database and set target prices, minimum acceptable prices or simply list an item for sale at any price. Buyers are able to review items for sale and participate in auctions, or agree to pay the target price to purchase the items they choose. These markets provide great convenience to traders and their popularity is evidence of their advantages over traditional “bricks and mortar” based markets. However, electronic markets such as eBay do not allow the buyers to inspect goods prior to making a purchase commitment, and the costs of listing and shipping items make it economically unattractive to trade items of smaller value. Fragile items and valuable items are less likely to be traded in electronic markets because of the risk of damage or loss in shipping.

Some of these disadvantages are addressed by traditional trading markets such as swap meets and street markets where sellers meet at a pre-arranged physical location to trade similar or diverse goods, and buyers attend to purchase items. Collectibles can also be traded in consignment stores and specialty stores. These traditional trading markets allow the buyer to inspect items they are interested in prior to purchasing them. But they are not convenient—buyers and sellers must travel to a location that may be distant from their usual or planned locations. And the fixed costs associated with maintaining a physical presence must be included in the sale price which will make it less attractive to trade items of smaller value.

Recently proposed systems (U.S. Pat. No. 6,912,398 to Domnitz (2000), U.S. Pat. No. 7,680,697 to Hearn et. al. (2006)) use GPS-enabled mobile computing devices to provide buyers with information to assist them with locating sellers of goods within an acceptable travel distance or time of their current location. However, these systems presume sellers with premises such as retailers and other markets so carry the same disadvantages of other traditional markets.

### SUMMARY OF THE INVENTION

What is needed is a method of trading goods that offers the advantages of both electronic and traditional trading markets. Our invention, a mobile opportunistic trading system, provides such a market mechanism and is now described.

Traders list items they wish to trade along with ask prices or offer bids (“quotes”) on a trading server. Traders may optionally list on the trading server most or all of the items in their possession of a similar nature as a collection along with ask prices at which they would be willing to sell each item. They may also list all items they wish to purchase along with prices they are willing to pay for the items. They may also list for each item they wish to trade additional information related to the distance or time they are willing to travel in order to trade the item.

A potential trade exists when one or more sellers have listed an item which one or more buyer has expressed interest in purchasing. A compatible quote exists when one or more seller's ask price for an item is below or close to one or more buyers' bid price for the same or a similar item.

The mobile opportunistic trading system may be used by traders to organize and participate in a planned opportunistic market. For a planned market, two or more traders agree to travel to a pre-arranged location at a specific time and register this intent with the trading server.

However, it is not necessary for traders to plan markets. Traders may carry one or more mobile computing devices that use a GPS, or other mechanism to determine their present location. Their one or more mobile computing devices register their current locations with the trading server. The trading server may identify two or more traders either within an acceptable distance of each other, or planning to travel within an acceptable distance of each other and with compatible quotes and notify them of this fact via a mobile computing device or via another form of communication. The traders may then choose to meet and complete the trade. They may also choose to create an instant opportunistic market to allow for other traders to take advantage of the trading opportunity.

The trading system may also enable traders to expand the market, for example by inviting specific traders to join the market, by notifying traders with quotes meeting specific criteria of the market, or by “advertising” the market—publishing the existence of the market to traders meeting specific criteria (based on location, planned location, membership of a group), or all traders.

Exemplary trading servers or mobile computing devices may be used to implement various embodiments of the systems and methods disclosed herein. The trading servers or mobile computing devices may include one or more processors and memory. Main memory stores, in part, instructions and data for execution by a processor to cause the computing system to control the operation of the various elements in the systems described herein to provide the functionality of certain embodiments.

Main memory may include a number of memories including a main random access memory (RAM) for storage of instructions and data during program execution and a read only memory (ROM) in which fixed instructions are stored. Main memory may store executable code when in operation.

The trading servers or mobile computing devices further may include one or more mass storage devices, portable storage medium drive(s), output devices, trader input devices, a graphics display, and peripheral devices.

The components may be connected via a single bus. Alternatively, the components may be connected via multiple buses. The components may be connected through one or more data transport means. Processor unit and main memory may be connected via a local microprocessor bus, and the mass storage device(s), peripheral device(s), portable storage device, and display system may be connected via one or more input/output (I/O) buses.

The mass storage device(s), which may be implemented with a magnetic disk drive or an optical disk drive, may be a non-volatile storage device for storing data and instructions for use by the processor unit. Mass storage device may store the system software for implementing various embodiments of the disclosed systems and methods for purposes of loading that software into the main memory. Portable storage devices may operate in conjunction with a portable non-volatile storage medium, such as a floppy disk, compact disk or Digital video disc, to input and output data and code to and from the computing system.

The software for implementing various embodiments of the systems and methods disclosed herein may be stored on such a portable medium and input to the computing system via the portable storage device.

Input devices may provide a portion of a trader interface. Input devices may include an alpha-numeric keypad, such as a keyboard, for inputting alpha-numeric and other information, or a pointing device, such as a mouse, a trackball, stylus, or cursor direction keys or touch-screens. In general, the term input device is intended to include all possible types of devices and ways to input information into the trading servers or mobile computing devices. As further means of inputting information, the computing devices may include voice recognition capabilities.

Additionally, the trading servers or mobile computing devices may include output devices. Suitable output devices include speakers, printers, network interfaces, and monitors. Display system may include a liquid crystal display (LCD) or other suitable display device. Display system may receive textual and graphical information, and processes the information for output to the display device. In general, use of the term output device is intended to include all possible types of devices and ways to output information from the computing system to the trader or to another machine or computing system.

Peripherals may include any type of computer support device to add additional functionality to the trading servers or mobile computing devices. Peripheral device(s) may include a modem or a router or other type of component to provide an interface to a communication network. The communication network may comprise many interconnected computing systems and communication links. The communication links may be wireline links, optical links, wireless links, or any other mechanisms for communication of information.

The components contained in the trading servers or mobile computing devices may be those typically found in computing systems that may be suitable for use with embodiments of the systems and methods disclosed herein and are intended to represent a broad category of such computing components that are well known in the art. Thus, the computing system may be a personal computer, hand held computing device, telephone, mobile computing device, workstation, server, minicomputer, mainframe computer, or any other computing device. The computer may also include different bus configurations, networked platforms, multi-processor platforms, etc.

Various operating systems may be used including Unix, Linux, Windows, Macintosh OS, Palm OS, MS-DOS, MINIX, VMS, OS/2, and other suitable operating systems. Due to the ever changing nature of computers and networks, the description of the trading servers or mobile computing devices is intended only as a specific example for purposes of describing embodiments. Many other configurations of the computing system are possible having more or less components.

Mobile computing devices with means of determining location are used in this invention. It is intended that these devices may be smart phones, or other mobile devices. In addition to the aforementioned features, the mobile computing device(s) contain means of determining location such as, but not limited to GPS, trader input, radio signal triangulation or radio signal strength measurement or radio or other time of flight difference, Wifi or other signal network identification.

### BRIEF DESCRIPTION OF DRAWINGS

FIG. 1 is a block diagram of the key functional elements in a mobile opportunistic trading market system in an embodiment of the invention.

FIG. 2 is a flow chart describing the actions in determining and creating an opportunistic market in an embodiment of the invention.

FIG. 3 shows overlapping trade regions where traders have indicated their interest in discovering trading opportunities.

FIG. 4 shows a number of traders moving in a geographic area leading to overlapping instant market objectives.

FIG. 5 shows a travel itinerary for a trader overlapping the trading regions for a number of other traders.

FIG. 6 shows a market listing comprising bid and ask quotes for an item being traded.

FIG. 7 describes the functions performed by mobile computing devices used in an embodiment of the invention.

FIG. 8 describes how traders may use a client application to browse catalogues of their items in an embodiment of the invention.

FIG. 9 describes how traders may use a client application to determine a region in which they are willing to trade items in an embodiment of the invention.

FIG. 10 describes how traders may use a client application to plan a market in an embodiment of the invention.

FIG. 11 describes how traders may use a client application to notify the trading system they plan to attend a market in an embodiment of the invention.

FIG. 12 describes how traders may use a client application to notify the trading system they are attending a market in an embodiment of the invention.

FIG. 13 shows the states managed by the trading server for an item trade in an embodiment of the invention.

FIG. 14 describes how traders may use a client application to notify the trading system they have completed a trade in an embodiment of the invention.

FIG. 15 describes how traders may use a client application to advertise an instant market objective in an embodiment of the invention.

FIG. 16 describes how traders may use a client application to create an instant market in an embodiment of the invention.

### DETAILED DESCRIPTION OF THE INVENTION

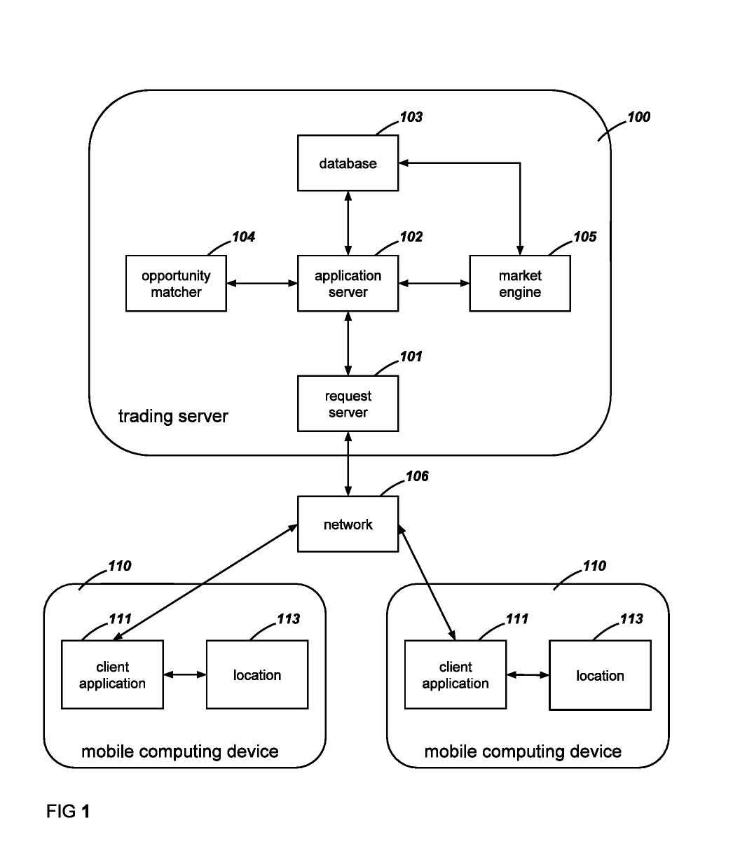

FIG. 1 is a block diagram of a mobile opportunistic trading market system in an embodiment of the invention. The system comprises a trading server 100 communicating with one or more mobile computing devices 110 by a network 106. The mobile computing devices execute a client application 111 to communicate with the trading server 100.

The mobile computing devices 110 are held by or are proximate to two or more traders and include a location device 113 such as a GPS receiver with the capability to determine the physical location of the mobile computing device, and make this information available to the client application 111.

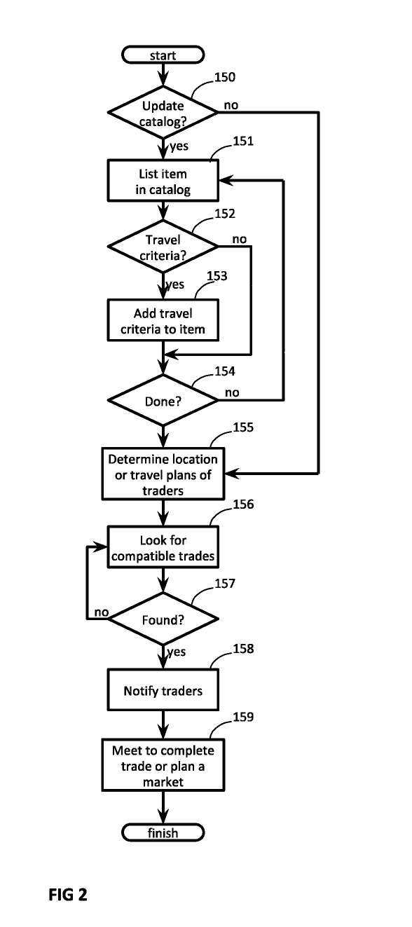

FIG. 2 is a flow chart describing the how an opportunistic market is created. If no catalogues of items that may be traded exist on the server then items may be listed on the trading server by the traders 151. Each item listed may optionally also be associated with travel criteria detailing an acceptable travel time or travel distance for the trader to be willing to trade the item 153. Each item quote may optionally specify a price threshold beyond which the trading server will not consider other quotes to be trading opportunities. For bid quotes the threshold defines the highest ask price that will be considered an opportunity, and for ask quotes it defines the lowest bid price that will be considered an opportunity.

The trading server is notified of the current location of each trader or of their travel plans 155. The trading server compares the lists of items to be traded on the basis of trade quotes and travel criteria 156. If two or more traders have listed items with compatible quotes and are either currently located, or plan to travel within an acceptable distance or equivalently within an acceptable travel time of each other according to the associated travel criteria, the trading server will notify the matched traders of the opportunity to trade 158. The traders then choose to meet and trade, or may optionally decide to create an instant opportunistic market or plan an opportunistic market and may optionally choose to advertise the market to selected traders or to many other traders 159.

Those skilled in the art will appreciate that the invention requires that the trading server has knowledge of the location of traders, and that this may be determined by other means than described here. Additionally those skilled in the art will recognize that the partitioning of the described embodiment of the invention is a matter of convenience. Other computing devices may be used to perform these same functions or that functions performed by one of the named devices may equivalently be performed by other of the named devices. For example, functions performed by the trading server may be performed in a distributed fashion by one or more mobile computing devices. Alternatively, the functions performed by the mobile computing devices may be performed by the trading server, or by a different computing device physically separated from the mobile computing device(s). Is this case the mobile computing devices may perform only the functions of accepting trader input and presenting information to the trader. The function of determining and reporting the trader location may be performed by the same mobile computing device as the device running the client application, or it may be performed by a separate mobile computing device, or the trader location may be determined by other means.

Returning now to FIG. 1 we provide a detailed description of an embodiment of the trading system. FIG. 1 is a block diagram of a mobile opportunistic trading market system. The system comprises a trading server 100 communicating with one or more mobile computing devices 110 by a network 106. The trading server 100 comprises a network facing request server 101, internally communicating with an application server 102, utilizing an opportunity matcher 104, a market engine 105, and a database 103. The mobile computing device 110 executes the client application 111 to communicate with the trading server 100.

It will be apparent to those skilled in the art that the request server 101, opportunity matcher 104, application server 102, market engine 105, and database 103 may be one or more software programs running on a single trading server computer, or they may be software programs running on one or more separate computing devices and communicating with a trading server computer. Furthermore, the embodiment of the invention provided here makes use of communications over the internet. Those skilled in the art will appreciate that other networks such as private networks or cellular telephone networks and other kinds of network communications may be used. Additionally, multiple instances of all trading server 100 components may be deployed to satisfy demand from mobile computing devices 110.

The database 103 provides persistent storage of all data required to operate the trading server 100.

The request server 101 receives all requests from mobile computing devices 110. It serves all static data requests directly, and hands more complex requests to the application server 102.

The application server 102 is responsible for processing of requests that modify and query dynamic state of the trading server 100. It defers the processing of some requests to specialized components such as opportunity matcher 104 and market engine 105. Requests are satisfied by retrieving data from and storing data in the database 103.

The opportunity matcher 104 matches trading opportunities between trader quotes in overlapping geographic regions, and in opportunistic markets. Requests from mobile computing devices 110 related to trading opportunities are processed in this component.

The market engine 105 is responsible for running trading markets when they become active. It matches buy and sell quotes to create item trades. Requests from mobile computing devices 110 related to active markets are processed by this component.

An embodiment of the invention includes two or more mobile computing devices 110, each held by or located proximate to two or more traders and running a client application 111. The client application 111 sends requests to the trading server 100 and receives responses to enable traders to perform several functions which are described in more detail in the following text.

In an embodiment of the invention, the mobile computing devices 110, also include a location device 113 such as a GPS receiver with the capability to determine the physical location of the mobile computing device, and make this information available to the client application 111. In an embodiment of the invention the location device is contained within the mobile computing device 110.

The trading server 100 maintains item catalogs that are used by the client application 111. The item catalogs can be predefined by the trading server 100, or they can be defined by individual traders updating the catalogs using a client application 111, or they can be crowd sourced by multiple traders working collaboratively using their client applications 111.

Using the client application 111 traders define one or more quotes to buy or sell items from the catalogs stored on the trading server 100. The trader quotes are stored on the trading server 100 to detect trading opportunities.

Using the client application 111 traders can also define a geographic region on the trading server 100 where they are willing to travel to trade items with other traders. The trading server 100 compares quotes for all traders with overlapping trading regions to discover trading opportunities. On discovery of trading opportunities (by having matching buy and sell quotes within their specified thresholds) the trading server 100 sends notifications to the mobile computing devices 110 of the traders for which trading opportunities were discovered. Traders are able to see trading opportunities using the client application 111.

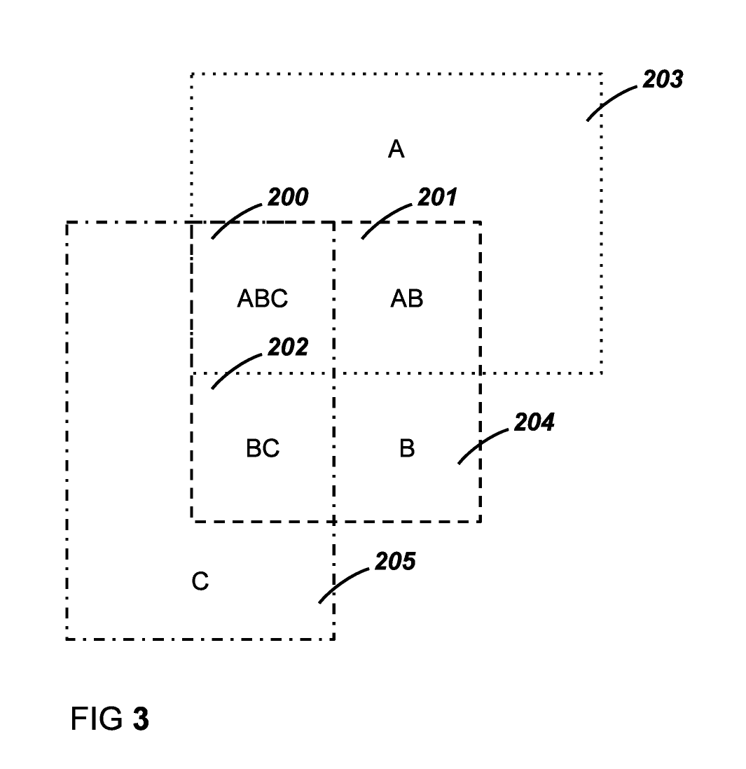

FIG. 3 shows overlapping rectangular trading regions A 203, B 204, and C 205. Each region was defined by a different trader. The area labeled ABC 200 is where all trading regions overlap, AB 201 is where trading regions A 203 and B 204 overlap, BC 202 is where trading regions B 204 and C 205 overlap, areas A 203, B 204, and C 205 are each areas where the trader regions do not overlap with other trader regions. A trading region may be disjoint and/or non-rectangular.

Using the notation A&B to represent trading opportunities between the trader defining region A and the trader defining region B, the trading server 100 will send to the trader defining region A 203 a notification for A&B in area AB 201, and A&B+A&C for area ABC 200. The trading server 100 will send to the trader defining region B 204 a notification for A&B in area AB 201, B&C for area BC 202, and A&B+B&C for area ABC 200. The trading server 100 will send to the trader defining region C 205 a notification for B&C in area BC 202, and A&C+B&C for area ABC 200.

Those skilled in the art will appreciate that trading regions need not be contiguous nor need they be any specific shape. May be created manually by traders, or automatically from information about traders habits and plans. May be created on mobile device, via web app, or browser interface to trading server or some other computing device.

Using the client application 111 traders may create markets for trading items a number of different ways. Markets consist of an aggregation of item buy and sell quotes from one or more traders.

Opportunistic markets can be planned by a trader to be held at a geographic location at a specific time. These planned opportunistic markets (or planned markets) can be made public, or can be kept private to one or more groups of traders, or private to one or more individual traders. Other traders who are permitted to see the market are notified of the trading opportunities that exist in the planned market and may indicate that they will attend the market.

Another kind of opportunistic market is the instant opportunistic market (or instant market). Traders can configure the client application 111 to periodically send their current geographic location to the trading server 100 along with a set of quotes and regions for items they wish to trade. Each region containing one or more item quotes represents an instant market objective for those items. The trading server 100 does not publish the location of traders or their instant market objectives. When the trading server 100 detects instant market objectives with compatible quotes that are overlapping each other it initiates a process to bring the traders together. The trading server 100 sends a notification to the mobile computing devices 110 of both traders to request permission to tell the other trader their current location. If both traders give permission then the trading server 100 reveals the location of the traders to each other via the client application 111 so that they can meet.

Traders may specify that their instant market objectives will be matched with all other instant market objectives, or they may restrict the matching to one or more groups of traders, or to one or more individual traders.

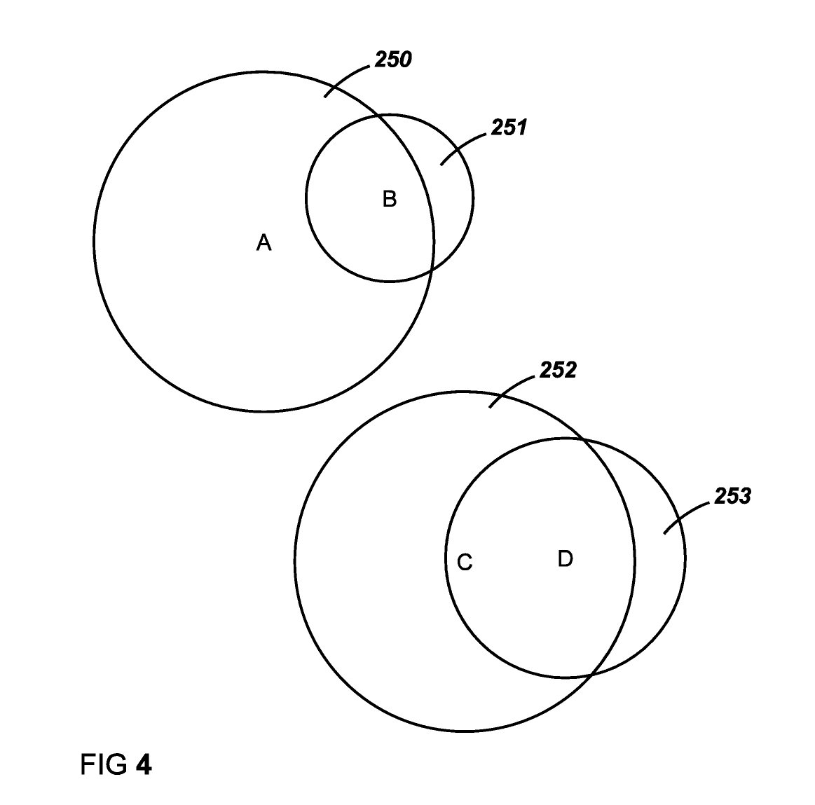

FIG. 4 shows the instant market objectives for four traders A, B, C, and D arranged in a geographic region. The instant market objective for a trader is centered at the geographic location of the trader, and has an area defined by a distance that is specified by the trader. In the diagram trader B is inside the instant market objective for trader A 250, but trader A is not inside the instant market objective for trader B 251, so no trade opportunities will be reported by the trading server 100. Traders C and D are inside each others' instant market objectives (252 and 253 respectively) so the trading server will calculate opportunities C&D and will report them to both traders.

Where this is not explicitly stated the term “distance” should be understood to indicate either a physical separation or a travel time.

Traders may use the client application 111 to plan a travel itinerary in the trading server 100 defining a route and schedule. This itinerary can be made public or can be kept private to one or more groups of traders, or private to one or more individual traders. Traders who are permitted to see the itinerary and are in a geographic area specified in the itinerary are notified of the trading opportunities that exist in with the trader. Any markets in a geographic area specified in an itinerary will be visible to the trader who planned that itinerary if the markets are not hidden by privacy settings.

When planning a travel itinerary a trader may define waypoints which are locations on the map that they plan to pass through and may include a planned time. Waypoint may also be defined with a stay duration or depart time.

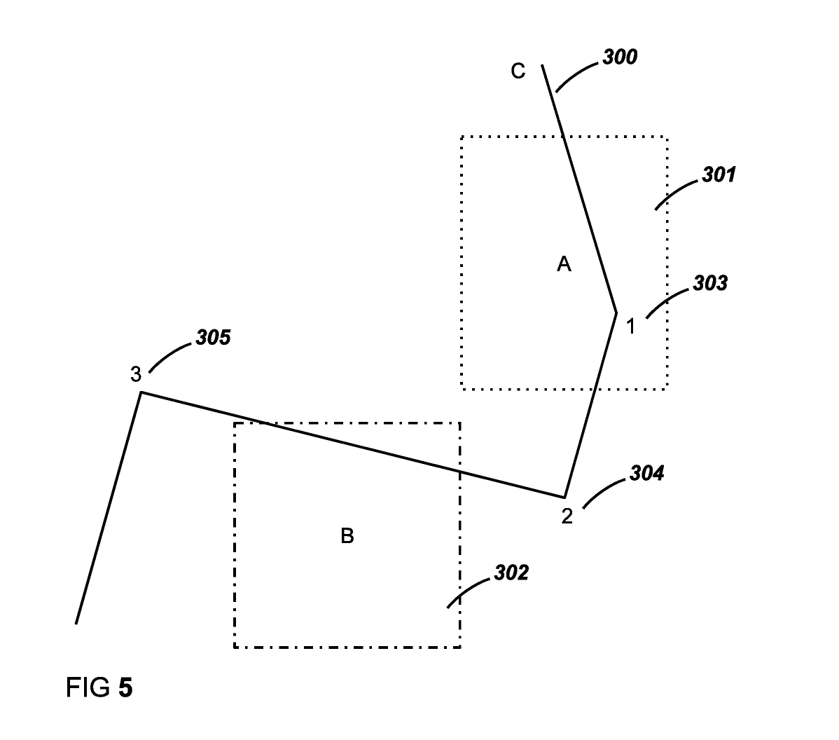

FIG. 5 shows a travel itinerary 300 for trader C that passes through the trading regions for traders A 301 and B 302. The itinerary contains three way points. Waypoint 1 303 is inside the trading region for trader A so the trading server 100 notifies traders A and C of opportunities A&C at that location at the planned waypoint time. Waypoint 2 304 and waypoint 3 305 are not inside trading regions but the planned route between those waypoints crosses the trading region for trader B 302 so the trading server 100 notifies traders B and C of opportunities B&C in that region between the times for waypoint 2 304 and waypoint 3 305.

Markets become active when two or more traders are in geographic proximity of the market at the time that market is scheduled so that items can be physically traded. Geographic proximity is defined as being within an acceptably small distance (for example 20 meters, or less than one minute of travel time) of the market location, or in proximity with a trader who is in attendance at the market.

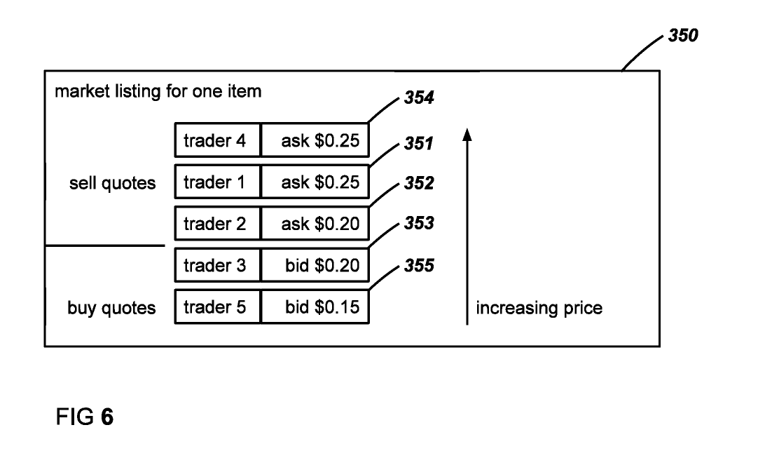

As shown in FIG. 6, in an active market all bid and ask queues for an item are sorted into descending price by the trading server. In the trading server 100. This is a market listing and is described in more detail further in this text. Quotes with the same price are organized in a first come first served sequence. Late ask quotes are sorted above earlier ask quotes with the same price, while late bid quotes are sorted below earlier bid quotes with the same price. A trader may only have one quote for each item in a market.

Whenever the price of the quote at the top of the bid queue for an item is equal to or greater than the price of the quote at the bottom of the ask queue for that same item the trading server 100 creates a pending trade by matching those quotes and removing them from their queues. While there is a gap between the price at the top of the bid queue and the bottom of the ask queue, a pending trade cannot be created.

Using their client application 111 either the buyer or seller in a trade can indicate that they require a mediator to participate in the trading process. During the trading process the mediator may hold the items being sold and if a payment is involved, they may also hold the payment. If the trading parties accept the trade the mediator will then give the items to the buyer and the payment to the seller. If either parties reject the trade then the mediator will return the items to the seller and the payment to the buyer. Mediators may also be recognized experts in and may be called upon to express an expert opinion on the nature or value of the items being traded.

Once a pending trade has been created in an active market the trading server 100 directs the buyer, the seller, and optionally a mediator towards each other so that the trade can be performed. The trading server 100 will cause the mobile computing devices 110 of the parties in the trade to emit a common (audible, light-based or other mutually detectable) signal and/or have the client application 111 instruct the parties to perform a physical action so that the parties can identify each other and move near enough to each other to exchange the item(s).

Once all parties are ready a trade will be completed by the seller showing the items to the buyer and then both the buyer and seller indicating they accept the trade using the client application 111 or other method of signaling this intent to the trading server 100. The trading server 100 will then send a notification to the parties' mobile computing devices 110 indicating that the trade has been accepted and then the items are given to the buyer.

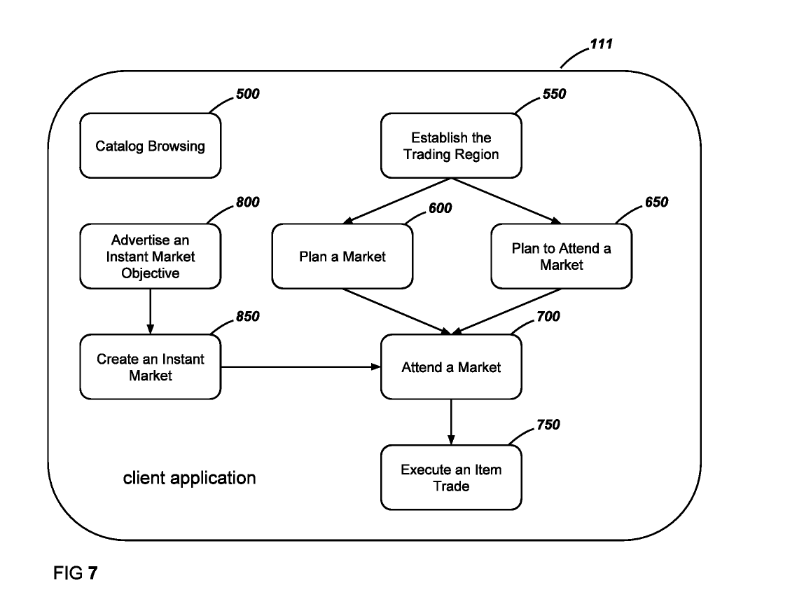

FIG. 7 shows a high level view the functions performed by the client application 111. The Catalog Browsing 500 function is always available, but before most other functions are available to the trader they must Establish the Trading Region 550. Once a trading region has been defined then the trader may Plan a Market 600 or Plan to Attend a Market 650 inside their defined trading region. Note that traders may define multiple trading regions and associate different item quotes with each trading region. At the planned location and time a trader may Attend a Market 700 where it is possible to Execute an Item Trade 750. Traders can also Advertise an Instant Market Objective 800 in the trading server 100 using their quotes. When the trading server 100 detects matching instant market objectives the matched traders can Create an Instant Market 850.

Traders can optionally Advertise an Instant Market Objective 800 in the trading server 100 causing the client application 111 to try to Create an Instant Market 850. Instant market objectives are not made visible to other traders, but follow the geographic location of the trader in the trading server 100. The client application 111 uses the GPS capabilities of the mobile computing device 111 to periodically publish the trader geographic location and instant trading range on the trading server 100. Whenever two traders with advertised instant market objectives with compatible trading intentions are in each others' instant trading range the trading server 100 will notify to the mobile computing devices 110 of each trader. If both traders agree to meet then the server creates an instant market for both traders to attend 700 and execute item trades 750.

In the following text a number of transactions or communications between the Client Application 111 and Trading Server 100 are listed and designated as “Name-of-request Request Rnn” (e.g. Thumbnail Request R4). These communications are further explained by providing sample Hypertext Transfer Protocol (HTTP) requests exchanging JavaScript Object Notation (JSON) that is used to implement these functions in an exemplary embodiment of the invention.

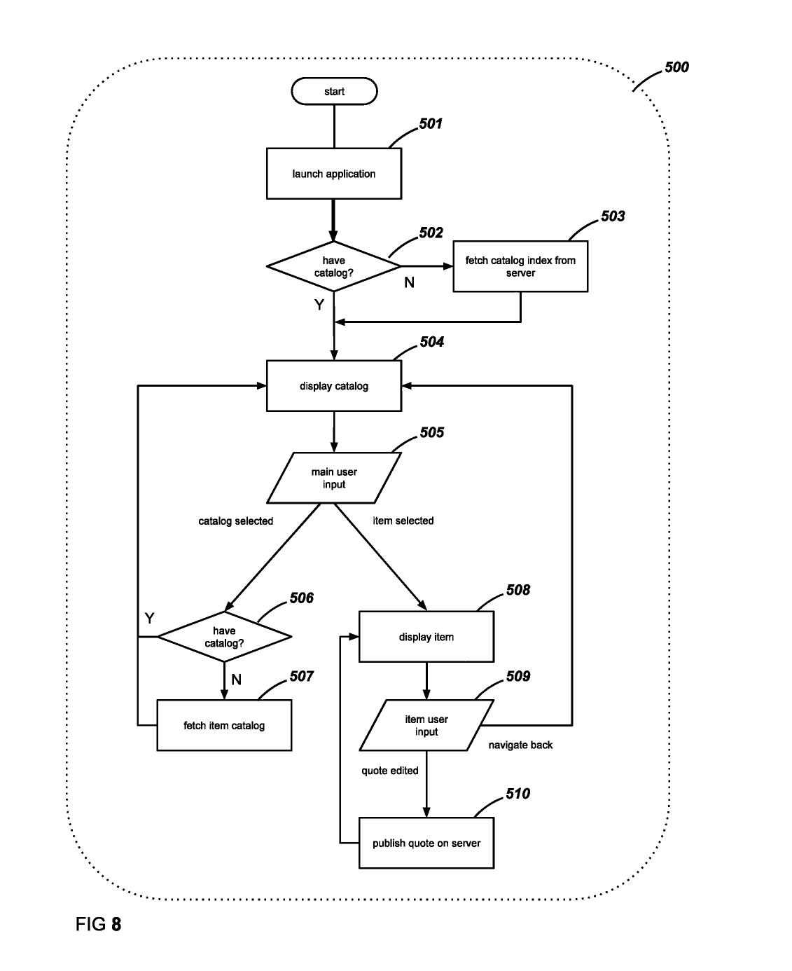

FIG. 8 describes the Catalog Browsing 500 function that is performed by the trader while using the client application 111.

In step 501 the trader launches the client application 111 on their mobile computing device 110.

In step 502 the client application 111 checks to see if it has a copy of the catalog index (which contains a list of all item catalogs in the trading server 100). The first time the application is executed, the catalog index will not be present on the mobile computing device 110 so must be fetched from the trading server 100 using step 503, otherwise processing continues using step 504.

In step 503 the root catalog is not present so the client application 111 fetches it from the trading server 100 via the Root Catalog Request R1 and then stores it locally to avoid requiring a download operation every time the client application 111 is executed in the future.

After the initial download the client application 111 periodically updates the root catalog from the trading server 100 to detect changes in item catalogs listed in the root catalog.

In step 504 the client application 111 displays the currently selected catalog. Catalogs and items have associated thumbnail images. If the thumbnail does not exist on the mobile computing device 110 then it is automatically fetched from the trading server 100 via the Thumbnail Request R4.

In step 505 the client application 111 waits for and reacts to trader input. If the trader selects a item catalog then processing continues at step 506, otherwise if an item is selected then processing continues at step 508.

In step 506 when the trader selects an item catalog the client application 111 checks to see if it has a copy of that catalog. If the catalog is not present it needs to be fetched from the trading server 100 using step 507 before it can be displayed, otherwise processing continues using step 504 with the selected catalog.

In step 507 the selected item and thumbnail catalogs are fetched from the trading server 100 respectively via the Item Catalog Request R2 and Thumbnail Catalog Request R3. The catalogs may be stored locally to avoid requiring a download operation every time the catalog is displayed.

After the initial download the client application 111 automatically downloads updated item catalog and thumbnails from the trading server 100 when a change is detected via the root catalog.

In step 508 when the trader selects an item from a catalog the client application 111 displays the description of the selected item from the item catalog.

In step 509 the client application 111 waits for and reacts to trader input on the item display. The trader can navigate back to the catalog display at step 504, or edit a quote to define how many of the displayed item they wish to buy or sell, and the price at which they are willing to trade the item. They may optionally select previously defined travel criteria for an item and privacy settings for the item. Editing a quote causes processing to continue at step 510. The privacy settings can be used by the trader to determine whether the quote will be visible to no one, selected individuals, groups of individuals or to anyone.

In step 510 the client application 111 publishes the edited quote on the trading server 100 via the Trading Intentions Request R5.

Trading regions are a geographic areas where the trader is willing to travel to trade items with other traders. Trading regions are established using the client application 111 and is sent to the trading server 100.

The trading server 100 locates all traders (or items) with overlapping trading regions and compares their item quotes to discover trading opportunities. A trading opportunity exists for an item in an geographic area (which can be part of a trading region) when one trader has published a buy quote for that item and another trader in the same area has published a sell quote.

After a trader has sent their region to the trading server 100, the trading server 100 will notify the trader of every buy or sell opportunity in that region.

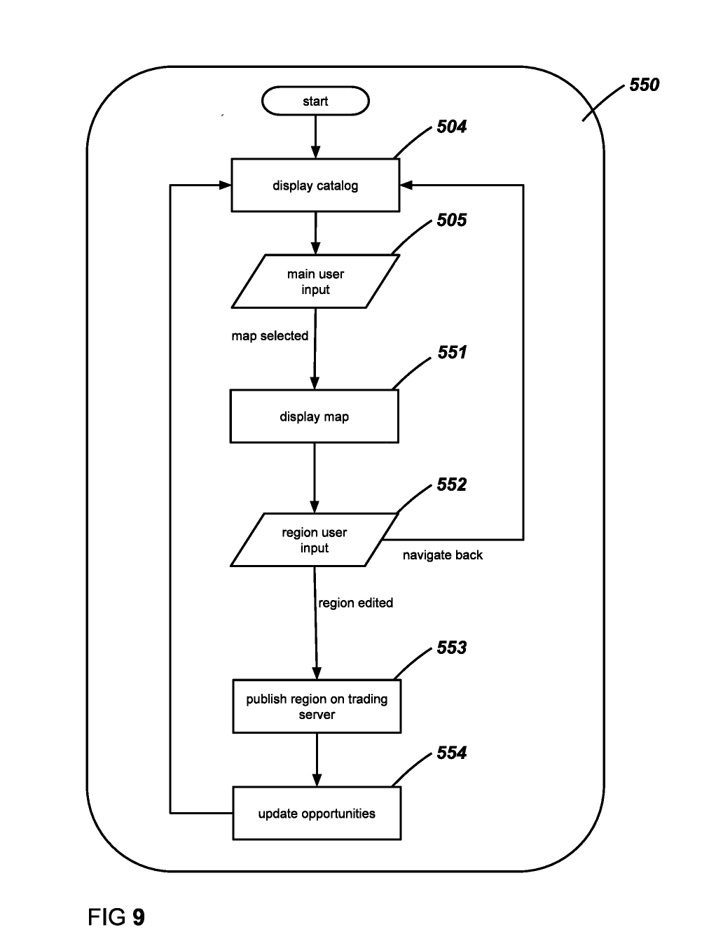

FIG. 9 describes the Establish the Trading Region 550 function that is performed by the trader while using the client application 111.

In step 504 while displaying the currently selected catalog the client application 111 also provides the ability to navigate into a map display.

In step 505 the application waits for and reacts to trader input on the catalog display. When the trader navigates to the map display processing continues at step 551.

In step 551 the application displays a map showing either the current location of the trader, or their trading region. Before the trader has established their trading region the client application 111 will display the current physical location of the trader (if available). Once a trading region has been established the client application 111 will display that region.

In step 552 the client application 111 waits for and reacts to trader input on the map. The trader can highlight a trading region where they are willing to travel to trade with other traders, they can modify their previously defined trading region, or they can navigate back to the display catalog. If the trading region is modified then processing continues at step 553.

In step 553 the client application 111 sends the trading region to the trading server 100 as a collection of map tiles via the Trading Region Request R6.

When the trading server 100 receives the Trading Region Request R6 it updates the trader's location and trading region on the trading server 100 and then calculates any trading opportunities with other traders. The server response to a Trading Region Request R6 contains a summary of all of the trading opportunities for the trader. This is returned to the client application 111.

In step 554 on receiving the collection of trading opportunities from the trading server 100 the client application 111 stores those opportunities on the mobile computing device 110 and updates them on the map.

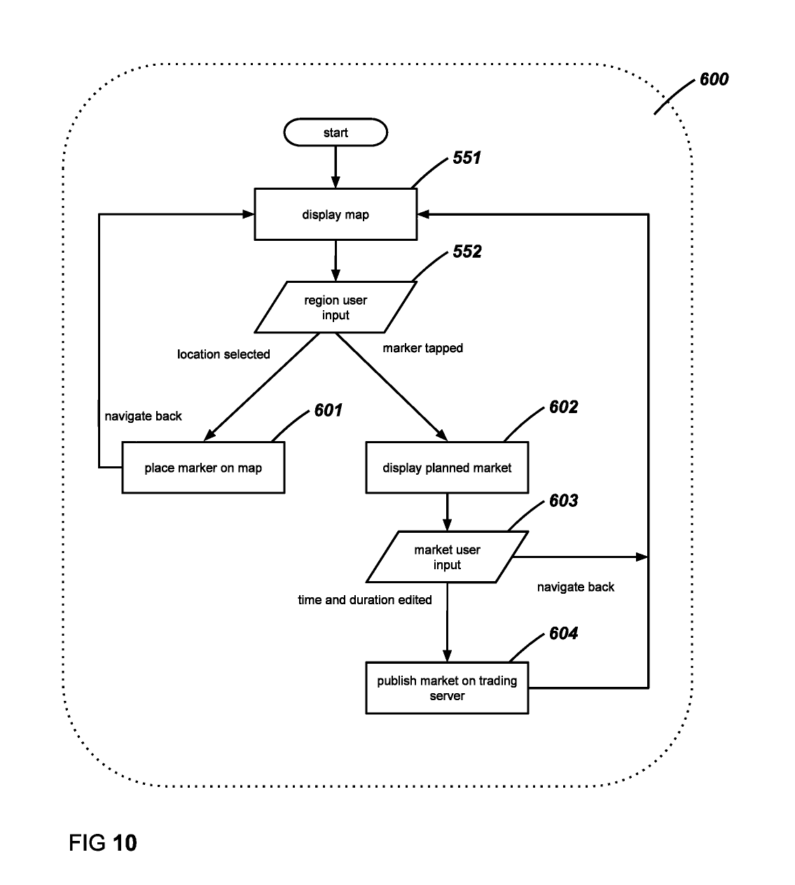

FIG. 10 describes the Plan a Market 600 function that is performed by the trader while using the client application 111.

At any time a trader can plan a market for trading items. This is done by identifying a geographic location, and the time and duration that they will be present at that location. When the client application 111 publishes this information on the trading server 100 the trading server 100 creates a planned market that is visible to all other traders in the same geographic region.

Note that it is not a requirement in the invention for all potential traders to be informed. It is understood that in some cases it might be desirable that some traders be excluded, either by choice or to satisfy different levels of service, or for other reasons.

When a trader plans a market, all of the item quotes present on the trading server 100 for that trader are added to that planned market.

All quotes in a planned market are compared with quotes for each trader in the same geographic region to determine the trading opportunities that exist in the market. Traders are notified of the opportunities in each planned market in their region.

In step 551 while displaying the map containing the trading region, the client application 111 also allows the trader to indicate that they wish to plan a market in their trading region.

It will be appreciated by those skilled in the art that it is not necessary for the geographical information to be presented to the traders in graphical form. It may be preferred by the traders, or where display capabilities or network communication speeds are limited it may be preferable to present this information in a textural format.

In step 552 the client application 111 waits for and reacts to trader input on the map. The trader can search for an address or landmark where they wish to place a market marker continuing processing in step 601, or they can tap on or drag a previously defined market marker continuing processing at step 602.

In step 601 when the trader performs a place search (by address, landmark, or business name, for example) the client application 111 places a market marker on the map. This can then be dragged or tapped on to define further market details.

In step 602 when the trader taps on a market marker the client application 111 displays the planned market page showing details of the planned market.

In step 603 the client application 111 waits for and reacts to trader input on the planned market page. The trader can define market details such as date, time, duration and privacy settings. Once all required settings have been defined the client application 111 will allow the trader to publish the planned market on the trading server 100 continuing processing at step 604.

The trader can also simply navigate back the trader location display.

In step 604 the client application 111 sends the market details to the trading server 100 via the Plan Market Request R8. Markets planned by one trader are visible to all other traders in the same geographic region if they are publicly visible. Markets that are not public are only visible to the traders who match the privacy settings of the market.

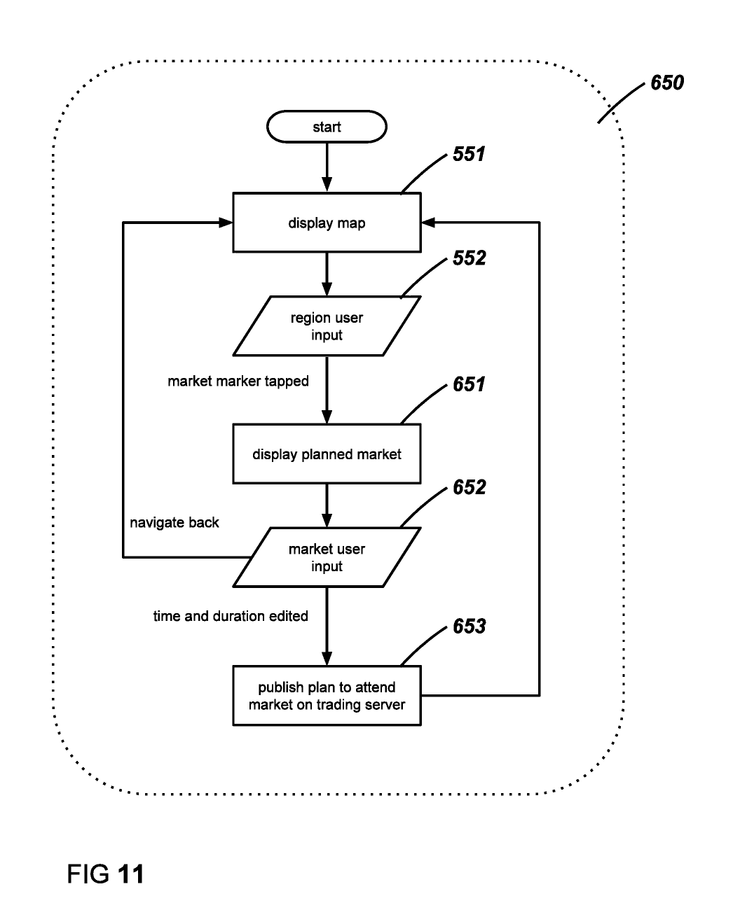

FIG. 11 describes the Plan to Attend a Market 650 function that is performed by the trader while using the client application 111.

At any time a trader can indicate that they plan to attend a market that was planned by a different trader.

When the client application 111 publishes the trader's plan to attend the market on the trading server 100 the trading server 100 adds all of that trader's quotes to the planned market. A market aggregates all quotes for all traders planning to attend that market.

When the trading opportunities in a market change as a result of other traders planning to attend that market, or cancelling their plan to attend that market then the trading server 100 notifies traders of their changed opportunities.

In step 551 while displaying the map containing the trading region, the client application 111 displays markers on the map indicating markets planned by other traders.

In step 552 the application waits for and reacts to trader input on the map. When the trader taps on a marker indicating a market planned by another trader processing continues in step 651.

In step 651 the client application 111 displays the planned market page.

In step 652 the client application 111 waits for and reacts to trader input on the planned market page. The trader can define the time and duration that they plan to attend the market. Once both time and duration have been defined the client application 111 allows the trader to publish their plan to attend on the trading server 100 continuing processing at step 653.

If desired the trader can also simply navigate back the map display showing their trading region.

In step 653 the client application 111 publishes the trader's plan to attend the market on the trading server 100 via the Attend Market Request R9.

The client application 111 can display also display a list of planned markets in the trader's region. The trader can select a market from this list and indicate or cancel their plan to attend the market.

The mechanisms for negotiating trades in an embodiment of the invention will now be described.

The trading server 100 aggregates all quotes published in a planned market into a single market. The market is visible as a collection of item market listings, each with public queues of bid and ask quotes. Both the bid and ask queues are sorted into descending price. This causes the lowest ask quote to be sorted closest to the highest bid quote. Quotes with the same price are organized in a first come first served sequence. Late ask quotes are sorted above earlier ask quotes with the same price, while late bid quotes are sorted below earlier bid quotes with the same price. A trader may only have one quote for each item in a market.

An example of the market listing 350 of one item in a market is shown in FIG. 6. where traders are numbered in the order that they joined the market. A market is made up of one or more item market listings.

Trader 1 entered an ask quote for $0.25 351. Trader 2 then entered an ask quote for $0.20 352 which is a lower price than 351 so the quote is given higher priority. Trader 3 then entered a bid quote for $0.20 353. Trader 4 then entered an ask quote for $0.25 354 which is the same price as 351 but as it was entered after 351 it has lower priority and is sorted above of 351. Trader 5 then entered a bid quote for $0.15 355 which is lower than 353 so is sorted below 353.

Note that ask quote 352 and bid quote 353 have the same price so can be joined to create a pending trade 401 in an active market.

Traders are only told which quotes are theirs, all other quotes are anonymous. This will normally be desirable. In special cases, some or selected quotes may be public. For example, if the market is to be operated as an auction—conventional, Dutch or “second price”, or if the nature of the items being traded requires it. In such cases it may also be desirable for the market listings to be sorted in a different order to that shown in FIG. 6.

As quotes for items in the market are added, removed, or modified the trading server 100 notifies all traders in the same geographic area who have indicated a desire to trade those same items. Traders also planning to attend the market are notified.

Trading is only performed in a market once it becomes active. Planned markets become active at the scheduled time and geographic location when two or more traders are physically present at that market. The client application 111 uses the geolocation capabilities of the mobile computing device 110 to detect trader attendance at the market.

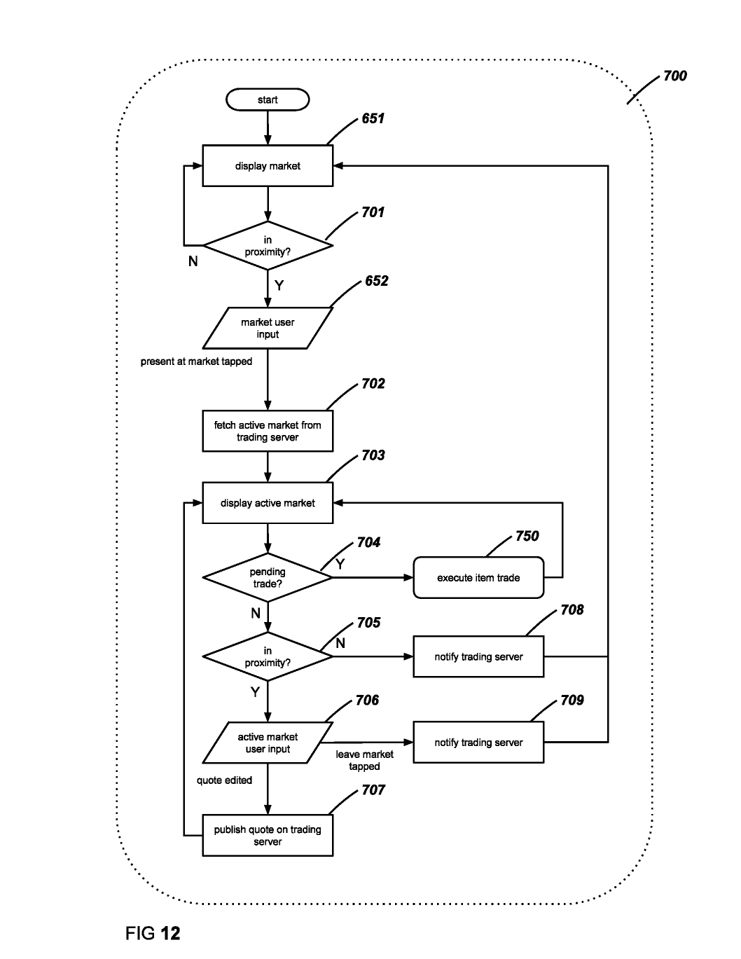

FIG. 12 describes the Attend a Market 700 function that is performed by the trader while using the client application 111.

For traders to attend a market they must in geographic proximity of that market at the planned market time. Geographic proximity is defined as being within an acceptably small distance (for example 20 meters, or less than one minute of travel time) of the market location, or within proximity of a trader who is present at the market.

When the client application 111 detects that the trader is present at the planned market location at the scheduled time it allows the trader to indicate that they are attending that market. The trader can optionally indicate that they are an expert and are available to act as a trade mediator when required. The client application 111 then indicates trader presence by sending a notification to the trading server 100. Once two traders have indicated they are attending the market it becomes active in the trading server 100. When a market becomes active the trading server 100 sends a notification to the client applications 111 of all traders with overlapping regions when constraints imposed by privacy settings are met.

The trading server 100 only includes quotes in an active market from traders currently attending that market.

When a market becomes active the trading server 100 sends all quotes in the active market to the client applications 111 of all traders attending that market.

When a new trader indicates that they are attending an active market the trading server 100 sends their client application 111 all of the quotes in that market. The client applications 111 for all other traders attending are sent an update of the active market including quotes from the new trader.

In an active market, whenever the price of the quote at the top of the bid queue for an item is equal to or greater than the price of the quote at the bottom of the ask queue for that same item the trading server 100 creates a pending trade by matching those quotes and removing them from their queues. While there is a gap between the price at the top of the bid queue and the bottom of the ask queue, a pending trade cannot be created.

The pending trade is created at the average of the prices in the matching quotes. The average price is used to prevent buyers using a high bid price simply for the purpose of jumping the queue.

The trading server 100 sends a notification to the client applications 111 of matched buyers and sellers in a pending trade. This notification causes their mobile computing devices 110 to alert them of the pending trade so that they can indicate they are ready to perform the item trade.

In step 651 the client application 111 displays the planned market page.

In step 701 when the client application 111 detects that the mobile computing device 110 is in the proximity of the planned market at the planned time it enables a “present at market” control on the display.

In step 652 the client application 111 waits for the trader to indicate that they are present at the market, continuing at step 702.

In step 702 the client application 111 uses a Market Presence Request R10 to indicate the trader is attending the market and a Market Quotes Request R11 to fetch the list of quotes in the active market from the server. If the trader is the first to attend the market then quotes will not be returned by the trading server 100 until the second trader attends. Once the initial state of the market has been obtained the client application 111 periodically uses the Market Signal Request R12 to obtain incremental updates from the trading server 100.

In step 703 once the list of quotes in the active market have been received the client application 111 shows the active market display. This lists all of the quotes providing trading opportunities for the trader in the active market.

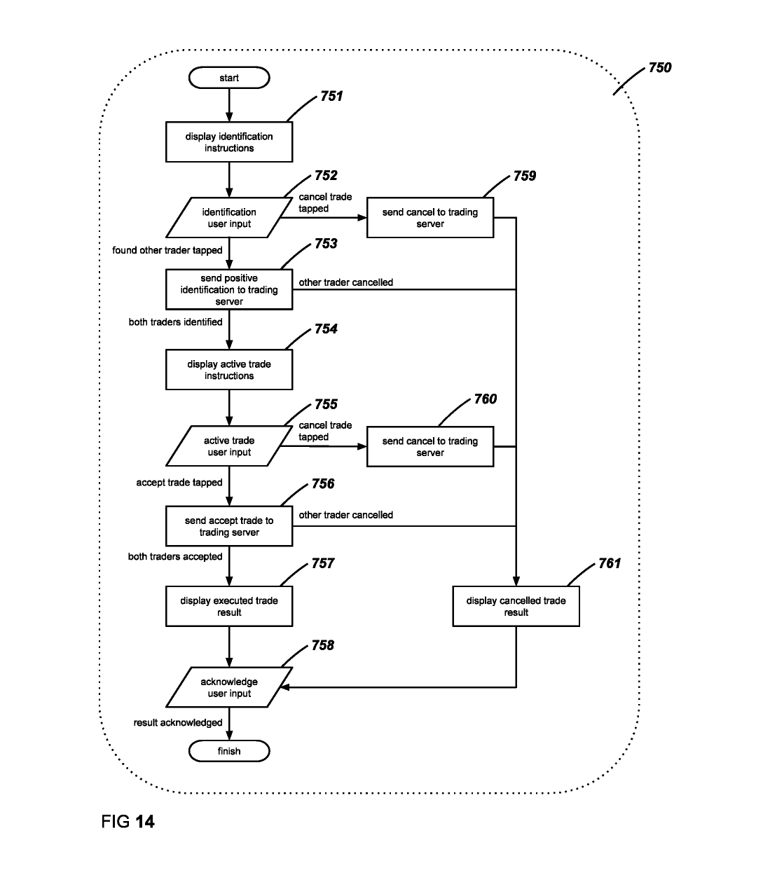

In step 704 when the trading server 100 creates a pending trading that includes the trader it sends a notification via the Market Instructions Request R13 to the mobile computing device 100 of the trader and the client application 111 starts the process to execute the item trade. This process is described in FIG. 14.

In step 705 if the client application 111 detects that the trader has left the proximity of the active market then the client application 111 continues processing at step 708.

In step 706 if there is no pending trade notification from the trading server 100 then the client application 111 waits for trader input. The trader can modify any of the quotes that they have in the active market, continuing processing at 707, or they can leave the active market, continuing processing at step 709.

In step 707 when the trader changes a quote in the active market the client application 111 publishes the new quote on the trading server 100 via the Trading Intentions Request R5.

In step 708 when the trader leaves the proximity of the market the client application 111 sends a Market Presence Request R10 to the trading server 100 to indicate that the trader has left the market. The client application 111 then returns the planned market display.

In step 709 the client application 111 sends a Market Presence Request R10 to the trading server 100 to indicate that the trader has left the market and returns the planned market display.

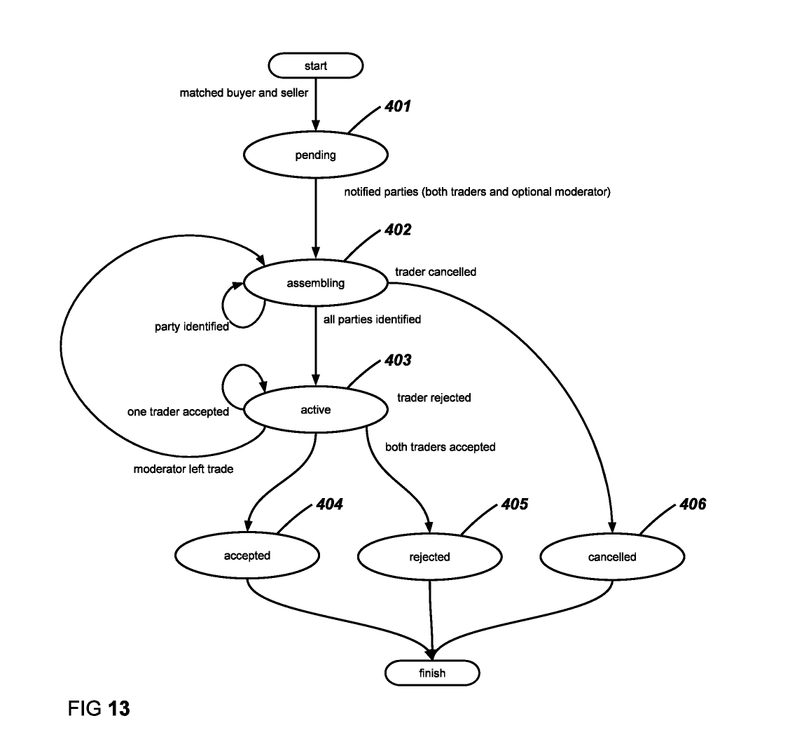

FIG. 13 shows the states of an item trade. The state is managed by the trading server 100 in response to events from the client application 111. It is understood that trading systems implementing only some of these states, or adding equivalent states, or sub-dividing these states are also anticipated by the invention.

Execution of pending trades begins with the traders being (anonymously) introduced to each other so that the trade can be performed. The trading server 100 does this by directing the traders to perform a recognizable action.

There are many possibilities for “recognizable actions”, and an embodiment of the invention may offer a just a few of these, or a large number. In an embodiment of the invention the traders may select from a variety of actions including raising an arm with hand held in such a manner as to create a recognizable gesture, raising one or both arms held at specific angles, raising one or both arms bent to a specified amount, sitting or lying down; moving to a specified location, facing in a specific direction, to raise specified objects, moving, greeting or speaking specified words to third party known to both traders, raising a mobile computing device programmed to perform an identifiable action such as flashing a light or displaying recognizable images, patterns or colors, holding up items which are universally recognizable, or recognizable to select individuals, or speaking specific words, or emitting specific sounds.

The actions involving a third party may be preferable when that same third party is also requested to be a mediator as described earlier.

Once traders have been introduced, the trading server 100 coordinates the physical transfer of the item from the seller to the buyer and optionally transfers the agreed price from the buyer's trading account on the trading server 100 to the seller's trading account on the trading server 100.

The pending state 401 means that a buyer and seller who are both present at an active market have agreed to exchange one or more items at an agreed item price. Trades are created automatically by the trading server 100 in an active market by matching buyer and seller quotes.

If there are three or more traders present at the active market then either the buyer or the seller can request that a mediator be involved in the trade. The mediator will act as an escrow agent for the trading parties.

The assembling state 402 means that the trading server 100 is directing the buyer, the seller, and optionally the mediator towards each other so that the trade can enter the active state.

The trading server 100 will instruct the parties to perform a recognizable action as described above so that the parties can identify each other and move near enough to each other to exchange the item.

Once the parties have identified each other they notify the trading server 100 using the client application 111 and the trading server 100 moves the trade into the active state. The trading server 100 will then choose the next pending trade and will move it into the assembling state.

When there are a large number of traders in attendance at an active market the trading server 100 may organize the traders into smaller groups so that more than one trade can be in the assembling state at the same time.

The cancelled state 406 means that a trade was cancelled by either the buyer or seller before the active phase.

The active state 403 means that the buyer, seller, and optionally a mediator are in the process of completing the trade. Trades are completed when they are accepted or rejected.

A trade will typically be completed by the seller showing the items to the buyer and then both the buyer and seller indicating they accept the trade using the client application 111 or other means of signaling this intent to the trading server 100. The trading server 100 will then send a notification to the parties' mobile computing devices 110 indicating that the trade has been accepted and then the seller hands the items to the buyer.

The buyer or seller can optionally reject the trade using the client application 111. The trading server 100 will then send a notification to all parties' mobile computing devices 110 indicating that the trade has been rejected.

When a mediator is involved in the trade the seller will hand all items to the mediator and then the mediator will hold them while the buyer and seller decide whether to accept or reject the trade. The trading server 100 will notify the mediator's mobile computing device 110 of the result of the trade. If the trade is rejected then the mediator hands the item(s) back to the seller. If the trade is accepted then the mediator hands all copies of the item to the buyer.

A mediator can leave an active trade at any time. The trading parties can request another mediator using the client application 111 causing that trade to fall back to the assembling state, or can continue with the active trade without a mediator. When leaving an active trade the mediator hands all copies of the item back to the seller.

The active state 403 will only persist for a short duration. If no action is performed within a specified period of this (for example five minutes) then the trade is automatically rejected. If both the buyer and seller agree to extend the active state 403 then the automatic rejection will be delayed for another predetermined time.

The accepted state 404 means that the trade was performed and the buyer has received all copies of the item and the seller has received the agreed price for all copies of the item.

Accepted trades create transactions on the trading server 100. The trading server 100 updates the database 103 transferring the traded item(s) from the seller to the buyer, stores a transaction recording the executed trade in the database 103, and the returns a status to the client applications 111 of both traders indicating that the trade has been executed.

The rejected state 405 means that either the buyer or the seller rejected the trade during the active state 403.

When a trade is rejected the quotes that were matched to create the pending trade are entered back into the active market on the trading server 100.

FIG. 14 describes the Execute an Item Trade 750 function that is performed by the trader while using the client application 111.

In step 751 the client application 111 displays instructions from the trading server 100 for identifying the other trader involved in the trade. Both traders will be instructed to perform a recognizable action as described earlier. The identification instructions are contained in the Market Instructions Request R13 response that initiated the trade execution.

In step 752 the client application 111 waits for trader input to indicate whether they have found the other trader, or that they have cancelled the trade. When the trader indicates they have identified the other trader the client application 111 continues processing at step 753. Cancelling the trade causes the client application 111 to continue processing at step 759.

In step 753 the client application 111 sends a Market Trade Action Request R14 to the trading server 100 indicating positive identification. The trading server 100 returns a status indicating the other trader has cancelled the trade, or that both traders have identified each other. When the status indicates that the other trader cancelled the trade the client application 111 continues at step 761. A status indicating both traders have identified each other causes the client application 111 to continue at step 754.

In step 754 the client application 111 displays instructions for executing the trade. An image of the item being traded and terms of trade will be displayed. The seller will be instructed to hand the item to the buyer or mediator.

In step 755 the client application 111 waits for trader input to indicate whether they have accepted or cancelled the trade. When the trader accepts the trade the client application 111 continues at step 756. When the trader cancels the trade the client application 111 continues at step 760.

In step 756 the client application 111 sends a Market Trade Action Request R14 to the trading server 100 indicating trade acceptance. The trading server 100 returns a status indicating if the other trader has accepted or cancelled the trade. When the status indicates that the other trader cancelled the trade the client application 111 continues at step 761. A status indicating both traders have accepted the trade causes the client application 111 to continue at step 757.

When the trade is accepted the trading server can optionally charge a commission from the buyer and/or the seller.

In step 757 the client application 111 stores the result of the executed trade on the mobile computing device 110 and displays it on the screen.

In step 758 the client application 111 waits for trader input to acknowledge the trade result before exiting back to the active market display in step 703.

In step 759 when the trader cancels the trade the client application 111 sends a Market Trade Action Request R14 to the trading server 100 indicating that the trade should be cancelled.

In step 760 when the trader cancels the trade the client application 111 sends a Market Trade Action Request R14 to the trading server 100 indicating that the trade should be cancelled.

In step 761 the client application 111 displays the details of the cancelled trade on the screen.

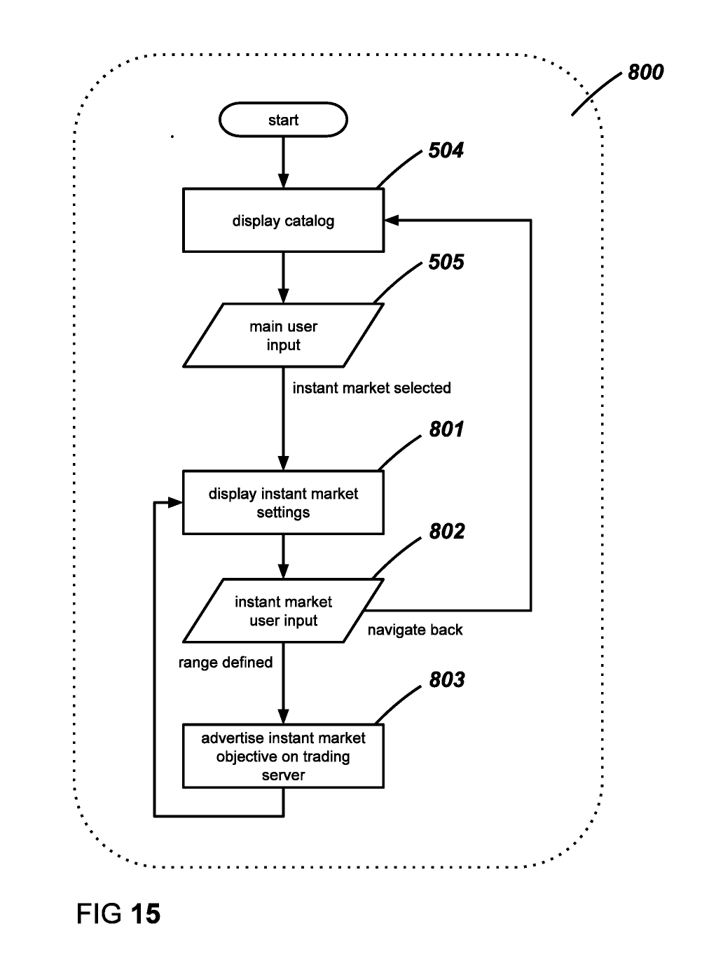

FIG. 15 describes the Advertise an Instant Market Objective 800 function that is performed by the trader while using the client application 111.

In step 504 while displaying the currently selected catalog the client application 111 also provides the ability to navigate into an instant market display.

In step 505 the client application 111 waits for and reacts to trader input. If the trader navigates to instant market then processing continues at step 801.

In step 801 the client application 111 displays the current settings for the trader's instant market objectives.

In step 802 the client application 111 waits for and reacts to trader input. If the trader defines an instant market objective distance and enables their instant market objective then processing continues at step 803, or they can navigate back to the display catalog at step 504.

In step 803 the client application advertises the instant market objective on the trading server 100 via the Instant Market Request R7.

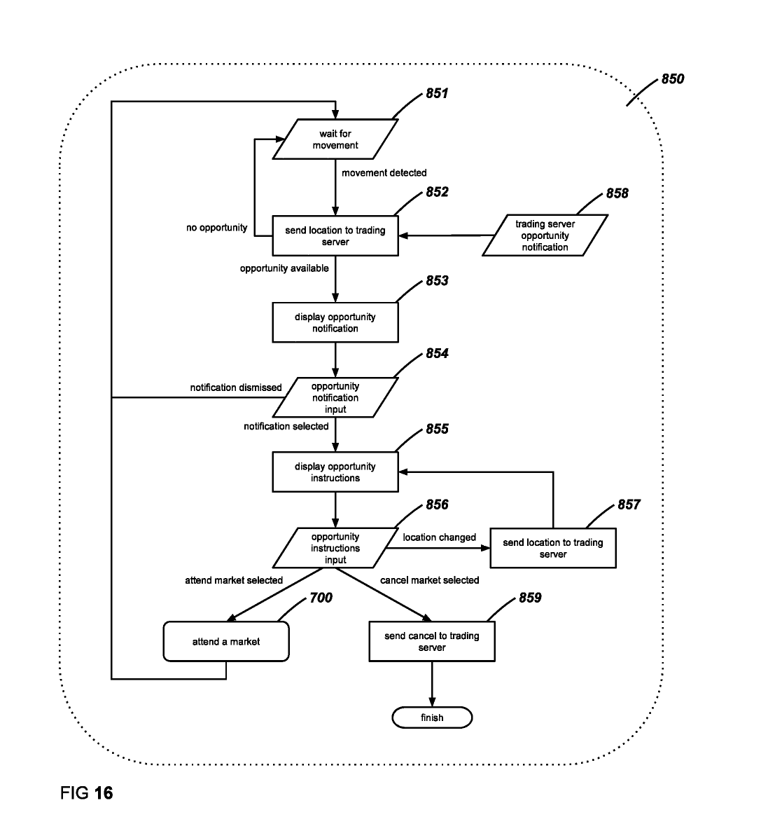

FIG. 16 describes the Create an Instant Market 850 function that is performed by the trader while using the client application 111.

In step 851 while the trader has an instant market objective enabled in the trading server 100 the client application 111 runs a background task that monitors the geographic location of the trader. When movement is detected processing continues at step 852.

In step 852 the client application 111 publishes the location of the mobile computing device 110 on the trading server 100 using the Instant Market Request R7. If the response from the server indicates there are no trading opportunities then processing returns to step 851. If the response indicates a matching instant market objective then processing continues at step 853.

When responding with a matching instant market objective the trading server 100 also sends a notification to the mobile computing device 110 of the other trader, causing it to begin processing at step 858.

In step 853 the client application 111 displays a notification summarizing the opportunity matching their instant market objective.

In step 854 the client application 111 waits for the trader to respond to the notification. The trader can dismiss the notification, continuing processing at step 851, or they can decide to view the opportunity, continuing processing at step 855.

In step 855 the client application 111 displays instructions for locating the other trader. The instructions indicate the location of and distance to the other trader. Once the trading server 100 detects that distance between the traders is less than 20 meters (for example) the instructions change to will tell each trader to raise their hand (for example) so that they can physically identify each other.

In step 856 the client application 111 waits for and reacts to trader input on the opportunity instructions display. The trader can stop advertising their instant market objective continuing processing at step 859, or they can indicate that they have located the other trader continuing execution at step 700.

While displaying the opportunity instructions the client application 111 monitors the location of the trader using the GPS capabilities of the mobile computing device 110. When the trader location changes processing continues at step 857.

At step 857 the client application 111 sends the location of the trader to the trading server 100 using the Instant Market Request R7. The trading server 100 responds with instructions to display on the display. Processing continues at step 855.

At step 858 the client application 111 of the other trader in the opportunity receives a notification from the trading server 100. This causes processing to begin at step 852.

At step 859 the client application 111 sends an Instant Market Request R7 to the trading server 100 to cancel their instant market objectives. The background task then terminates. On receiving the request the trading server 100 sends a notification to the other trader which resets processing back to step 852.

As described earlier, Trading Server Requests are made by the Client Application 111 in order to perform the functions of the invention. In an embodiment these requests are implemented using Hypertext Transfer Protocol (HTTP) requests exchanging JavaScript Object Notation (JSON). The Trading Server Requests used in this embodiment are now described.

R1—Root Catalog Request

This HTTP request is used by the client application 111 to fetch the root catalog from the trading server 100.

GET /catalog/root.json

The response is a JSON object containing a list of item catalog summaries. Each item catalog summary contains a unique id, a name, an item catalog version, a thumbnail catalog version, and a count of the number of items in the catalog.

{“format”:“v1”, “catalogs”:[{“uuid”:string,
“metadata_version”:integer, “thumb_version”:integer, “name”:string,
“num_items”:integer},{...}]}

R2—Item Catalog Request

This HTTP request is used by the client application 111 to fetch an item catalog from the trading server 100.

GET /catalog/<catalog-uuid>-item-list-v<metadata-version>.json

The response is a JSON object containing a list of item descriptions. Each item contains a unique id, a version, a name, and a variable collection of additional metadata depending on the type of the item.

{“format”:“v1”, “version”:integer, “items”:[{“uuid”:string,
“version”:integer, “name”:string, ...},{...}]}

R3—Thumbnail Catalog Request

This HTTP request is used by the client application 111 to fetch a thumbnail catalog from the trading server 100.

GET /catalog/<catalog-uuid>-thumb-list-v<thumb-version>.json

The response is a JSON object containing a list of thumbnail descriptions. Each item contains a unique id (which matches an item id from the corresponding item catalog), a variant (the invention supports the trading of variations of the same item), and a cryptographic hash of the item thumbnail image. The hash is used to detect when the thumbnail image has changed and a new one must be fetched from the trading server 100.

{“format”:“v1”, “version”:integer, “thumbs”:[{“uuid”:string,
“variant”:string, “thumb_sig”:string},{...}]}

R4—Thumbnail Request

This HTTP request is used by the client application 111 to fetch a thumbnail image from the trading server 100.

GET /static/thumb/xxx/yyy.jpg

The response is a thumbnail image.

R5—Trading Intentions Request

This HTTP request is used by the client application 111 to create, read, update, or delete item quotes for the trader on the trading server 100.

PUT Method

When the PUT method is used the body of the request is a JSON object that defines a list of item quotes. Item quotes that already exist on the trading server 100 will be replaced by this request, and item quotes that do not exist on the trading server 100 will be established by this request.

PUT /trading/item-list ? session-id=string
{“format”:“v1”, “items”:[{“uuid”:string, “variant”:string,
“buy”:integer, “price”:integer},{...}]}

The response is a JSON object indicating the result of the request.

{“status”:“OK”}

DELETE Method

When the DELETE method is used the body of the request is a JSON object that contains a list of item quotes to delete from the trading server 100.

DELETE /trading/item-list ? session-id=string
{“format”:“v1”, “items”:[{“uuid”:string, “variant”:string},{...}]}

The response is a JSON object indicating the result of the request.

{“status”:“OK”}

GET Method

When the GET method is used the trading server 100 returns the full list of item quotes that the trader has defined on the trading server 100.

GET /trading/item-list ? session-id=string

The response is a JSON object listing all of the item quotes defined on the trading server 100 for the trader.

{“format”:“v1”, “status”:“OK”, “items”:[{“uuid”:string,
“variant”:string, “buy”:integer, “price”:integer},{...}]}

R6—Trading Region Request

This HTTP request is used by the client application 111 to read or define a region on the map where the trader is willing to travel to trade with other traders. Any parts of the region that overlap with regions from other traders will cause the trading server 100 to search for trading opportunities between the trader and those other traders.

PUT Method

When the PUT method is used the body of the request is a JSON object that defines a list of map tiles. The current trader location (where the map is centered) is also sent to the trading server 100. Sending this request replaces any previously defined region on the trading server 100.

PUT /location/tiles ? session-id=string
{“format”:“v1”, “lat”:number, “lng”:number, “tiles”:[{“lat”:number,
“lng”:number},{...}]}

The response is a JSON object listing all of the items that can be traded, and where they can be traded. Opportunities can be present in a map tile or markets close to the current trader location.

{“format”:“v1”, “lat”:number, “lng”:number, “tiles”:[{“lat”:number,
“lng”:number, “items”:[{“uuid”:string,
“variant”:string},{...}]},{...}], “markets”:[{“id”:integer,
“items”:[{“uuid”:string, “variant”:string},{...}]},{...}]}

GET Method

Using the GET method does not modify the trader location or trading region on the trading server 100. It just retrieves the trading opportunities.

The response to the GET method is the same as the PUT method.

R7—Instant Market Request

This HTTP request is used by the client application 111 to enable or disable advertising of their item quotes as an instant market objective on the trading server 100.

PUT Method

When the PUT method is used the body of the request is a JSON object that defines the radius in metres of the market that is used to find matching instant market objectives from other traders.

PUT /market/instant ? session-id=string
{“format”:“v1”, “lat”:number, “lng”:number, “radius”:integer}

The response is a JSON object indicating the result of the request. If a trading opportunity is detected by the trading server 100 then the location of the other trader is returned along with instructions and a summary of the trading opportunities.

{“status”:“OK”, “lat”:number, “lng”:number, “instructions”:string,
“items”:[{“uuid”:string, “variant”:string},{...}] }

DELETE Method

When the DELETE method is used the trading server 100 will delete the instant market objective for the trader.

The response is a JSON object indicating the result of the request.

{“status”:“OK”}

R8—Plan Market Request

This HTTP request is used by the client application 111 to publish a new planned market on the trading server 100. The trading server 100 will automatically set a plan to attend the market for the trader at the planned time and duration.

The request body is a JSON object specifying the name of the market (that will appear on maps and in market listings), the geographic location of the market, the date, time, and duration of the market.

PUT /market/plan ? session-id=string
{“format”:“v1”, “name”:string, “lat”:number, “lng”:number,
“when”:string, “duration”:integer}

The response is a JSON object containing the unique server id of the market. This is used in subsequent requests to identify the market.

{“status”:“OK”, “market id”:integer}

R9—Attend Market Request

This HTTP request is used by the client application 111 to create, update, or delete a trader plan to attend a market on the trading server 100.

PUT Method

When the PUT method is used the body of the request is a JSON object that defines the time and duration that the trader will attend the planned market. If the trader hes not previously indicated that they plan to attend the market then the trading server 100 will create a plan to attend record for the trader. If the trader already has a plan to attend record for the market then it will be replaced.

PUT /market/attend ? session-id=string & market-id=integer
{“attend”:string, “attend_duration”:integer}

The response is a JSON object indicating the result of the request.

{“status”:“OK”}

DELETE Method

When the DELETE method is used the trading server 100 will delete the plan to attend for the trader. If a planned market is left with no traders planning to attend then the market will be deleted from the trading server 100.

DELETE /market/attend ? session-id=string & market-id=integer

The response is a JSON object indicating the result of the request.

{“status”:“OK”}

R10—Market Presence Request

This HTTP request is used by the client application 111 to indicate to the trading server 100 that the trader is present at a market, or has left a market.

PUT Method

The PUT method is used to indicate the trader is present at the market. The trading server 100 will enter all of the trader quotes into the active market when processing this request.

PUT /market/present ? session-id=string & market-id=integer

The response is a JSON object indicating the result of the request.

{“status”:“OK”}

DELETE Method

The DELETE method is used to indicate the trader has left the market. The trading server 100 will remove all of the trader quotes from the active market when processing this request.

DELETE /market/present ? session-id=string & market-id=integer

The response is a JSON object indicating the result of the request.

{“status”:“OK”}

R11—Market Quotes Request

This HTTP request is used by the client application 111 to fetch the current state of all quotes in an active market from the trading server 100.

GET /market/quotes ? session-id=string & market-id=integer

The response is a JSON object containing the current list of all quotes in the active market. The state of the active market is constructed from a stream of monotonically increasing numbered events. Each quote appears in the market as a result of an “add” event, and quotes are removed by “delete” events. The last_event_id identifies the point in time that the response represents. Each quote listed contains the event_id of the event that added that quote to the market.

After using this request to initialise the state of the market the client application 111 will typically use the Market Signal Request R12 to follow market activity.

{“format”:“v1”, “status”:“OK”, “last_event_id”:integer,
“quotes”:[{“event_id”:integer, “trader_id”:string, “when”:string,
“uuid”:string, “variant”:string, “buy”:integer,
“price”:integer},{“event_id”:integer, “trader_id”:string,
“when”:string, “uuid”:string, “variant”:string, “sell”:integer,
“price”:integer},{...}]}

R12—Market Signal Request

This HTTP request is used by the client application 111 to fetch the activity in an active market from the trading server 100 that has occurred since a particular point in time (identified by an event id).

GET /market/signal ? session-id=string & market-id=integer [ &
since-id=integer ] [ & wait ]

The response is a JSON object containing the list of all events that have occurred in the active market since the specified event.

{“format”:“v1”, “status”:“OK”, “last_event_id”:integer,
“events”:[{“event”:“add”, “event_id”:integer, “trader_id”:string,
“when”:string, uuid″:string, “variant”:string, “buy”:integer,
“price”:integer},{“event”:“delete”, “event_id”:integer},{...}]}

R13—Market Instructions Request

This HTTP request is used by the client application 111 as a long poll request to receive instructions from the trading server 100 while present at an active market.

GET /market/instructions ? session-id=string & market-id=integer

Identify Response

When the trading server 100 starts executing a pending trade it sends this response to both traders involved in the pending trade. The response is a JSON object containing instructions for each trader to identify the other trader.

{“format”:“v1”, “status”:“OK”, “action”:“identify”,
“instructions”:string, “buy_event_id”:integer,
“sell_event_id”:integer, “trade_id”:integer}

R14—Market Trade Action Request

This HTTP request is used by the client application 111 to signal trader actions on a trade that is currently being executed.

PUT /market/trade-action ? session-id=string & market-id=integer &
trade-id=integer & action=string

The response is a JSON object indicating the result of the request.

{“status”:“OK”}

While the description above contains many specificities, these should not be construed as limitations on the scope of our invention, but rather as an exemplification of the several embodiments described. Many other variations are possible.

What is claimed is:

1. A method for creating trading markets comprising the steps of
a. identifying two or more traders having listed items they wish to trade with compatible bid and ask quotes,
b. determining that the said two or more traders meet predetermined geographical criteria, and
c. notifying the said two or more traders of the potential to trade their items.

2. The method of claim 1 where bid and ask quotes are compatible when a bid quote for an item is within a predetermined amount of an ask quote for the item.

3. The method of claim 1 where the said predetermined geographical criteria are met by one or more of the following conditions
a. when said two or more said traders being are located within an acceptable travel time of each other or within an acceptable travel distance of each other
b. one or more of the said traders has travel plans that will result in the said traders being located within an acceptable travel time of each other or within an acceptable travel distance of each other at some time in the future.

4. The method of claim 1 where the steps of creating the trading markets are performed by a single computer system or a distributed computer system.

5. The method of claim 4 where the said computer system exchanges information between the said traders to facilitate trading.

6. The method of claim 5 where the said information includes instructions for said traders to perform specified actions enabling traders unknown to each other to identify each other.

7. The method of claim 6 where the said instructions include performing a recognizable action or gesture, holding a recognizable object aloft or creating recognizable sounds.

8. The method of claim 6 where the said instructions are provided to the said traders by a mobile computing device.

9. The method of claim 1 further comprising the step of identifying a third party who is willing to mediate a trade between two or more traders, the mediation consisting of one or more of the following steps
a. holding agreed payment for items being traded until traders agree on final price,
c. holding items to be traded until traders agree on final price,
b. expressing an opinion on the nature of the items being traded.

10. The method of claim 1 where the said traders complete a trade on terms agreeable to each other.

11. The method of claim 1 where the said lists of items held by traders are automatically updated with the results of the trade.

12. The method of claim 1 where a third party collects a payment for participation in markets.

13. The method of claim 1 where a third party collects a trade commission or other payment related to the trade.

14. The method of claim 3 where information related to the location or planned location of the said traders is used to plan a trading market.

15. The method of claim 14 where said traders advertise the said trading market.

16. The method of claim 15 where additional traders are invited to join the said trading market.

17. The method of claim 1 where said traders may include privacy settings for one or more of the said quotes determining which individuals the said one or more quotes will be disclosed to.

18. A trading system comprising
a. One or more databases containing lists of items that two or more traders wish to trade, the said items associated with predetermined geographical criteria, and
b. A trading server that identifies two or more traders compatible bid and ask quotes, and notifies the said two or more traders of the potential to trade their items.

19. The trading system of claim 18 where bid and ask quotes are compatible when a bid quote for an item is within a predetermined amount of an ask quote for the item.

20. The trading system of claim 18 where the criteria for determining that bid and ask quotes are compatible includes two or more traders meeting predetermined geographical criteria comprising one or more of
a. the two or more said traders are located within an acceptable travel time of each other or within an acceptable travel distance of each other, or
b. one or more of the traders has travel plans that will result in the said traders being located within an acceptable travel time of each other or within an acceptable travel distance of each other at some time in the future.

21. The trading system of claim 20 where the said trading server communicates with computing devices in proximity with traders to exchange information between the said traders to facilitate trading.

22. The trading system of claim 21 where the said computing devices are mobile computing devices held by traders.

23. The trading system of claim 21 where the said information includes instructions for said traders to perform specified actions enabling traders unknown to each other to identify each other.

24. The trading system of claim 23 where the said instructions include performing a recognizable action or gesture, holding a recognizable object aloft or creating recognizable sounds.

25. The trading system of claim 18 where the said trading server identifies a third party who is willing to mediate a trade between two or more traders, said mediation consisting of one or more of the following steps
a. holding agreed payment for items being traded until traders agree on final price,
b. holding items to be traded until traders until traders agree on final price,
c. expressing an opinion on the nature of the items being traded.

26. The trading system of claim 18 where the said traders complete a trade on terms agreeable to each other.

27. The trading system of claim 18 where the said lists of items held by the said traders are automatically updated with the results of the trade.

28. The trading system of claim 18 where the said trading server calculates a payment for participation in markets.

29. The trading system of claim 18 where the said trading server calculates a trade commission or other payment related to the trade.

30. The trading system of claim 21 where one or more traders receive information related to the potential trading market via the computing devices in proximity with the said traders and communicate to the trading server the desire to plan a trading market.

31. The trading system of claim 30 where said traders advertise the said trading market.

32. The trading system of claim 30 where additional traders are invited to join the said trading market.

33. The trading system of claim 18 where said traders establish privacy criteria on the said trading server for one or more of the said quotes determining which individuals the said one or more quotes will be disclosed to.
